(19) United States
(12) Patent Application Publication
(10) Pub. No.: US 2008/0284260 A1
(43) Pub. Date: Nov. 20, 2008

(54) ELECTROMAGNETIC ACTUATOR AND OPTICAL PICKUP DEVICE INCORPORATING ELECTROMAGNETIC ACTUATOR

(75) Inventor: Hideaki Miyamoto, Ogaki-shi (JP)

Correspondence Address: DITTHAVONG MORI & STEINER, P.C., 918 Prince St., Alexandria, VA, 22314, US

(73) Assignee: Sanyo Electric Co., Ltd., Moriguchi-shi (JP)

(21) Appl. No.: 12/108,270

(22) Filed: Apr. 23, 2008

(30) Foreign Application Priority Data
Apr. 24, 2007 (JP) 2007-114056

(51) Int. Cl. H02K 33/12

(52) U.S. Cl. 310/28

(57) ABSTRACT

An electromagnetic actuator has a base plate including a plurality of electric wires queued in a queued direction at an interval. Each electric wire produces a magnetic field when supplied with current. A movable portion is mounted on the base plate and is movable relative to the base plate in the queued direction. The movable portion includes a pole surface facing toward the electric wires. The movable portion is moved in the queued direction when magnetic attraction or magnetic repulsion is generated between the pole surface and the magnetic field produced by each electric wire. The pole surface is magnetically attracted by at least one of the electric wires facing toward the pole surface when the movable portion is being moved in the queued direction.

### CROSS-REFERENCE TO RELATED APPLICATIONS

This application is based upon and claims the benefit of priority from prior Japanese Patent Application No. 2007-114056, filed on Apr. 24, 2007, the entire contents of which are incorporated herein by reference.

### BACKGROUND OF THE INVENTION

The present invention relates to an electromagnetic actuator and an optical pickup device incorporating an electromagnetic actuator. More particularly, the present invention relates to an electromagnetic actuator using a monopolar magnet and an optical pickup device including an optical component driven by such an electromagnetic actuator.

Japanese Laid-Open Patent Publication No. 2006-87230 proposes a linear electromagnetic actuator (also referred to as movable magnet type linear motor device) for moving a permanent magnet by selectively exciting a plurality of coils.

The above linear electromagnetic actuator of the prior art uses, as a field magnet, a plurality of permanent magnets (multipolar magnet), which are multipolarly magnetized in a driving direction. The field magnet is mounted on a movable portion. A stationary portion is spaced from the field magnet of the movable portion by a predetermined distance and arranged facing toward the field magnet. A plurality of coils are aligned along the driving direction on a surface of the stationary portion. Current is supplied to a selected one of the coils to produce a magnetic field. Magnetic attraction or magnetic repulsion between the magnetic field and the field magnet of the movable portion produces thrust that moves the movable portion in the driving direction.

To mount a linear electromagnetic actuator on a small component such as an optical pickup, a field magnet having the desired magnetic force must be reduced in size or thickness. In order to reduce the multipolar magnet in size or thickness, permanent magnets of the multipolar magnet must also be reduced in size or thickness. However, reduction in the size or thickness of the multipolar magnet would result in drastic reduction of the magnetic force. In such a case, the magnetic force generated by the magnetic field produced by the coils would become insufficient for moving the movable portion. Thus, efforts have been made to use a monopolar magnet (single permanent magnet) as the field magnet.

### SUMMARY OF THE INVENTION

One aspect of the present invention is an electromagnetic actuator having a base plate including a plurality of electric wires queued in a queued direction at an interval. Each electric wire produces a magnetic field when supplied with current. A movable portion is mounted on the base plate and is movable relative to the base plate in the queued direction. The movable portion includes a pole surface facing toward the electric wires. The movable portion is moved in the queued direction when magnetic attraction or magnetic repulsion occurs between the pole surface and the magnetic field produced by each electric wire. At least one of the electric wires facing toward the pole surface attracts the pole surface when the movable portion is being moved in the queued direction.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1A is a top view and FIG. 1B is a cross-sectional view showing an electromagnetic actuator according to a preferred embodiment of the present invention;

FIGS. 2A, 2B, 3A, and 3B are cross-sectional views for illustrating the operation of the electromagnetic actuator shown in FIG. 1A;

FIG. 4 is a diagram of a circuit for controlling current supplied to coils of the electromagnetic actuator in the preferred embodiment;

FIGS. 5A and 5B are cross-sectional views illustrating the direction current flows in the electromagnetic actuator according to the preferred embodiment of the present invention;

FIG. 6 is a schematic diagram showing an optical pickup device incorporating the electromagnetic actuator according to the preferred embodiment of the present invention;

FIG. 7A is a top view and FIG. 7B is a cross-sectional view showing an electromagnetic actuator of the prior art; and

FIGS. 8A, 8B, 9A, and 9B are cross-sectional views illustrating the operation of the prior art electromagnetic actuator.

### DETAILED DESCRIPTION OF THE PREFERRED EMBODIMENTS

Representative embodiments of the present invention will now be discussed. To avoid redundancy, like or same reference numerals are given to those components that are the same or similar in all of the drawings. In the following description, the upper surface of a coil will refer to the surface facing a monopolar magnet.

### Electromagnetic Actuator

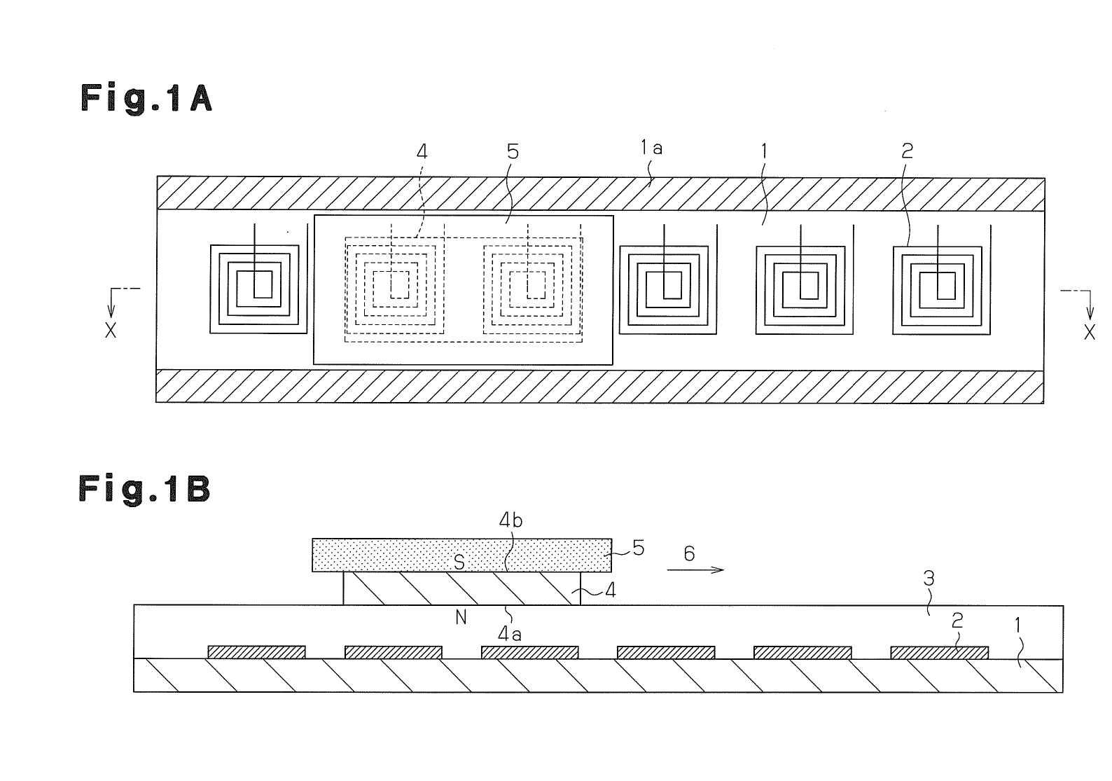

FIG. 1A is a top view of an electromagnetic actuator employing a monopolar magnet according to the present invention, and FIG. 1B is a cross-sectional view taken along line X-X of FIG. 1A.

The electromagnetic actuator of the illustrated embodiment includes a stationary portion 1 and a movable portion 5. A monopolar magnet 4 is attached to the movable portion 5.

A plurality of coils 2 are successively arranged at predetermined intervals along the upper surface of the stationary portion 1. The plurality of coils 2 are covered by a protective film 3. Guide rails 1a for guiding the movable portion 5 along the queued direction of the coils 2 is arranged on the protective film 3. The stationary portion 1 is fixed to, for example, a housing of the electromagnetic actuator. The coils 2 are electric wires formed from a conductive or metal material, such as copper (Cu) or aluminum (Al). The plurality of coils 2 may be aligned in a straight line. The current applied to the coils 2 is controlled so that one or more selected coils 2 produce a controlled magnetic field. Magnetic attraction or magnetic repulsion occurs between the coil 2 and the monopolar magnet 4 through such current control.

The monopolar magnet 4 is a permanent magnet and functions as a field magnet. The monopolar magnet 4 is attached to the lower surface of the movable portion 5 and includes pole surfaces 4a and 4b. The pole surface 4a (e.g., N-pole) faces toward the coils 2 arranged on the stationary portion 1. The monopolar magnet 4 has a size corresponding to about two coils. In the illustrated example, the monopolar magnet 4 has a length in the queued direction (along the guide rails 1a) that is equal to the distance between the upstream end of an upstream one of two adjacent coils and the downstream end of the other one of the two coils.

The movable portion 5 is formed from a silicon substrate, epoxy resin plate, or the like. The monopolar magnet 4 is formed from a ferromagnetic material, such as a ferrite magnet, a neodymium magnet, or the like. The monopolar magnet 4 and the movable portion 5 move along the protective film 3 of the stationary portion 1 in the queued direction (along the guide rails 1a) of the coil 2 and are spaced from the stationary portion 1 by a predetermined distance.

The stationary portion 1 is one example of a “base plate” in the present invention, the coil 2 is one example of a “electric wire” in the present invention, and the monopolar magnet 4 and the movable portion 5 are one example of a “movable portion” in the present invention.

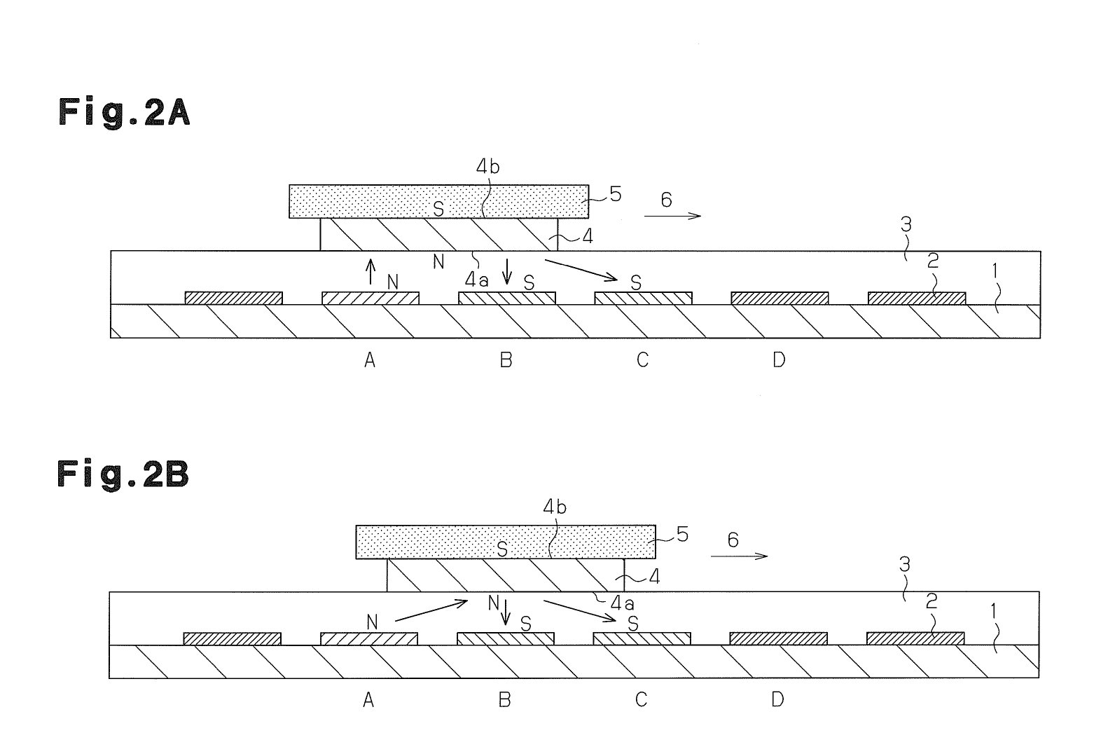

The operation of the electromagnetic actuator shown in FIG. 1 will now be discussed with reference to FIG. 2.

In the state shown in FIG. 2A, coils A and B are located immediately below the movable portion 5, and coils C and D are located frontward from the movable portion 5. In this state, current is supplied in the next manner so that each of the coils A, B, and C produce a magnetic field. A predetermined current is supplied to coil C so that an upper surface of coil C has an S-pole polarity. Current is supplied to coil A in a direction opposite to the current supplied to coil C so that an upper surface of coil A has an N-pole polarity. Current is supplied to coil B in the same direction as coil C so that an upper surface of coil B has an S-pole polarity. By controlling the supply of current in such a manner, magnetic attraction occurs between the N-pole of the monopolar magnet 4 attached to the movable portion 5 and the S-poles generated at coils B and C. Further, magnetic repulsion occurs between the N-pole of the monopolar magnet 4 and the N-pole at coil A.

In the state shown in FIG. 2A, the magnetic attraction between the monopolar magnet 4 and coil C produces the thrust for driving the movable portion 5 in the driving direction 6 relative to the stationary portion 1. In this state, magnetic attraction is maintained between the monopolar magnet 4 and coil B, which is located immediately below the monopolar magnet 4 (between the N-pole surface 4a of the monopolar magnet 4 and the opposing coil B). This keeps the movable portion 5 attracted toward the stationary portion 1.

When the movable portion 5 moves to the position shown in FIG. 2B, in addition to the magnetic attraction between the monopolar magnet 4 and coil C, magnetic repulsion between the monopolar magnet 4 and coil A acts as the thrust. This thrust further moves the movable portion 5 in the driving direction 6 relative to the stationary portion 1. The movable portion 5 is kept attracted to the stationary portion 1 by the magnetic attraction between the monopolar magnet 4 and part of coil C, which is located immediately below the monopolar magnet 4, in addition to the magnetic attraction between the monopolar magnet 4 and coil B, which is also located immediately below the monopolar magnet 4.

The supply of current to the coils A to C is stopped when the movable portion 5 is moved by a distance corresponding to one coil. Then, current is supplied to coils B to D, which are respectively located next to coils A to C, in the same manner as in the state of FIG. 2A. The timing for supplying current to the coil is controlled by using a position detector (not shown) for detecting movement of the movable portion 5 for a distance corresponding to one coil. The movable portion 5 is driven along the queued direction of the coils 2 arranged on the stationary portion 1 by magnetic attraction, magnetic repulsion, or a combination of magnetic attraction and magnetic repulsion between the coil 2 and the monopolar magnet 4.

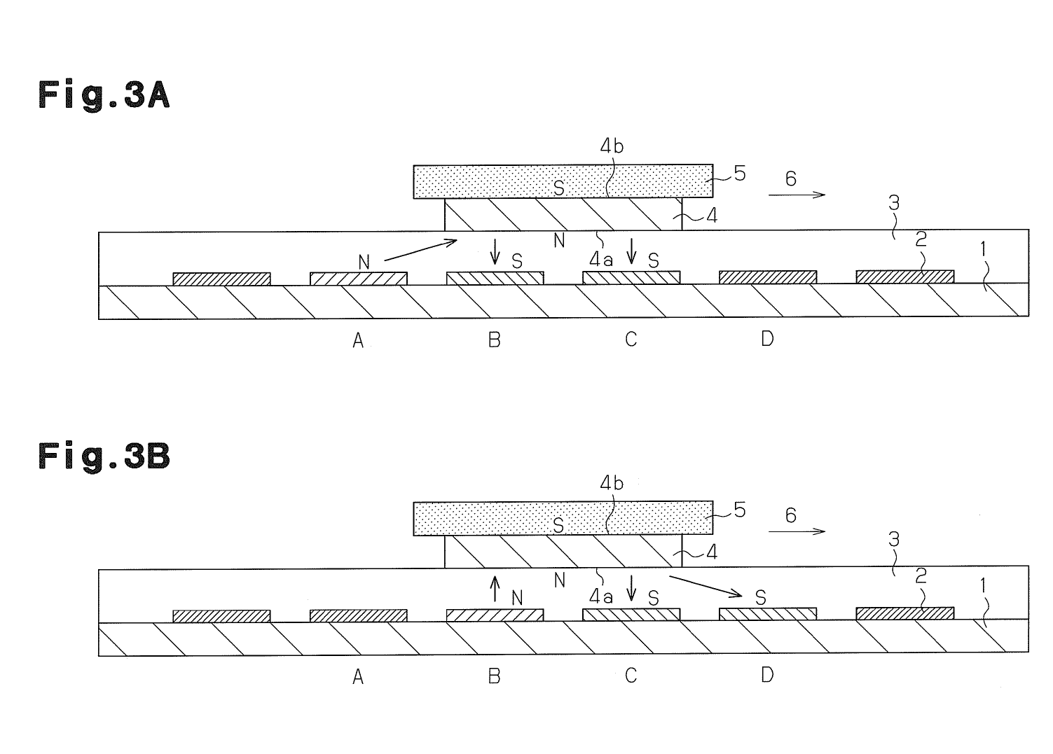

In the illustrated embodiment, magnetic attraction between the monopolar magnet 4 and the coil located immediately below the monopolar magnet 4 keeps acting on the movable portion 5 before and after switching the coils supplied with current. FIG. 3A shows a state before switching the coils supplied with current. In this state, magnetic attraction occurs between the monopolar magnet 4 and coil B, which is located immediately below the monopolar magnet 4. FIG. 3B shows a state after switching the coils supplied with current. In this state, magnetic attraction occurs between the monopolar magnet 4 and coil C, which is located immediately below the monopolar magnet 4. In this manner, the movable portion 5 is kept attracted to the stationary portion 1 by coil C before and after switching the coils supplied with current. This prevents the movable portion 5 from being moved away from a predetermined position on the stationary portion 1 even if an external force is applied to the movable portion 5.

In the illustrated embodiment, a coil is always located immediately below the monopolar magnet 4 so that magnetic attraction acts on the movable portion 5 of the movable portion 5 when the movable portion 5 is being driven. This stably drives the movable portion 5 and improves the driving reliability of the electromagnetic actuator.

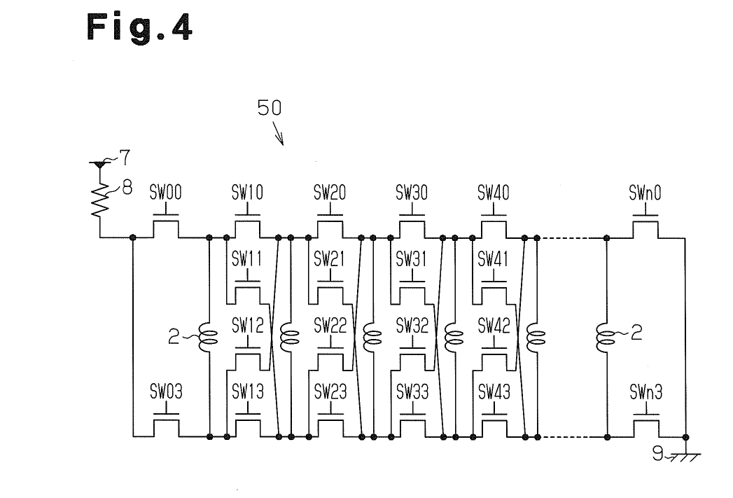

A method for controlling the current supplied to the coils 2 of the electromagnetic actuator will now be discussed. FIG. 4 is a circuit diagram of a current control circuit 50 for controlling the current supplied to each coil.

The current control circuit 50 uses the voltage of a power supply 7 and a resistor 8 to generate current that flows towards ground 9. A switch element, which is formed by an NMOS transistor, is connected to each end of each coil 2. A drive signal is provided from a control circuit (not shown) to a gate electrode of each NMOS transistor. Each switch element operates in accordance with the drive signal. Each switch element is activated when the drive signal has a high (H) level and is deactivated when the drive signal has a low (L) level. Each switch can switched between three states, namely, (1) a state in which current does not flow to the coil 2, (2) a state in which current flows in a first direction to the coil 2 (current causing magnetic repulsion that acts on the monopolar magnet 4), and (3) a state in which current flows in a second direction, which is opposite the first direction to the coil 2 (current causing magnetic attraction that acts on the monopolar magnet 4).

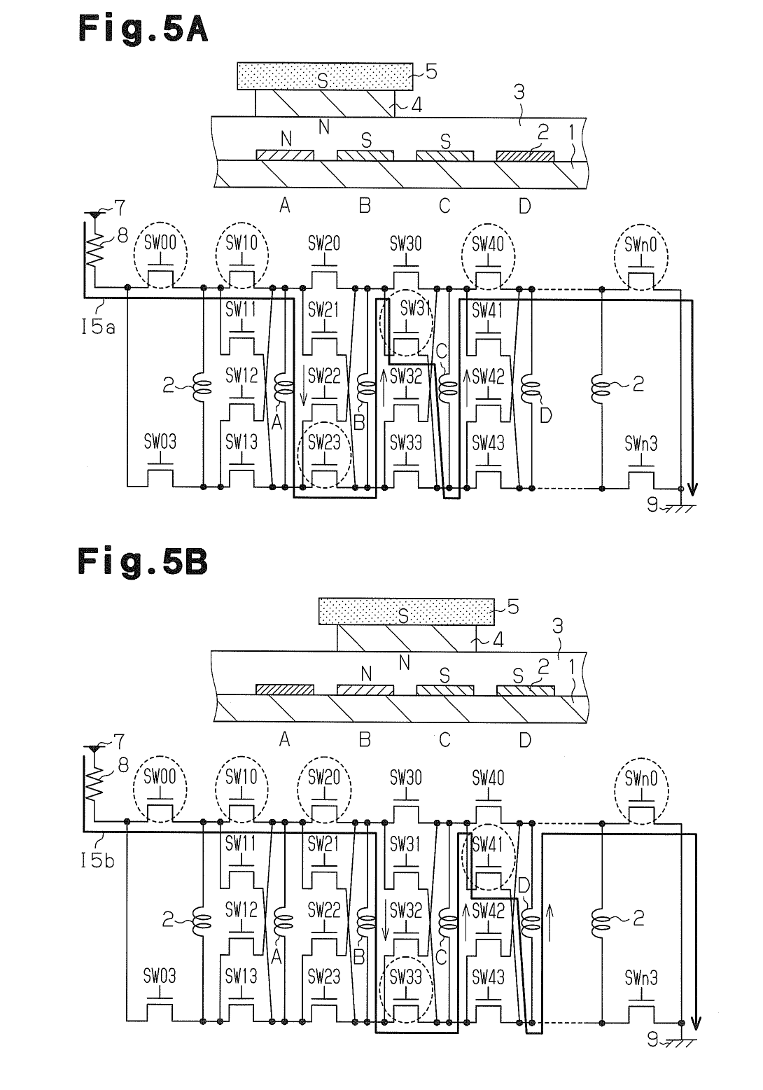

The control circuit provides switches SW00, SW10, SW23, SW31, SW40, . . . , and SWn0, which are each encircled by broken lines, with an “H” level drive signal and provides other switch elements with an “L” level drive signal to produce a magnetic field as shown in the state of FIG. 5A. In this case, current I5a flows to the current control circuit 50. The current I5a flows to coil A in a first direction and flows to coils B and C in a second direction. In the illustrated example, the upper surface of coil A has an N-pole polarity, and the upper surfaces of coils B and C have an S-pole polarity. The current I5a does not flow to the other coils 2 including coil D. Thus, a magnetic pole is not generated at the upper surfaces of the other coils.

Subsequently, when the movable portion 5 is moved by a distance corresponding to one coil to the position of the state shown in FIG. 5B, the control circuit switches the drive signal provided to each switch element. The control circuit provides switches SW00, SW10, SW20, SW33, SW41, . . . , and SWn0, which are encircled by broken lines with an “H” level drive signal and provides other switch elements with an “L” level drive signal. As a result, current I5b flows to a current control circuit 50. The current I5b does not flow to coil A. The current I5b flows to coil B in the first direction. The current I5b flows to coils C and D in the second direction. Therefore, a magnetic pole is not generated at the upper surface of coil A. The upper surface of coil B changes to an N-pole polarity, and the upper surfaces of coils C and D have an S-pole polarity.

The movable portion 5 is thus driven in the queued direction of the coils 2 by the magnetic attraction or magnetic repulsion between the monopolar magnet 4, which is attached to the movable portion 5, and the coils 2, which are attached to the stationary portion 1, by sequentially switching the switch elements.

The electromagnetic actuator of the illustrated embodiment has the advantages described below.

(1) When moving the movable portion 5, to which the monopolar magnet 4 is attached, along the queued direction (guide rails 1a) of the plurality of coils 2, the coil 2 immediately below the monopolar magnet 4 attracts the monopolar magnet 4. This keeps the movable portion 5 attracted to the stationary portion 1. Thus, the movable portion 5 is stably driven without being deviating from the driving direction 6. In this manner, the illustrated embodiment improves the driving reliability of the electromagnetic actuator.

Unlike the illustrated embodiment, it is difficult to stably drive a movable portion with a prior art electromagnetic actuator employing a monopolar magnet. The reason follows.

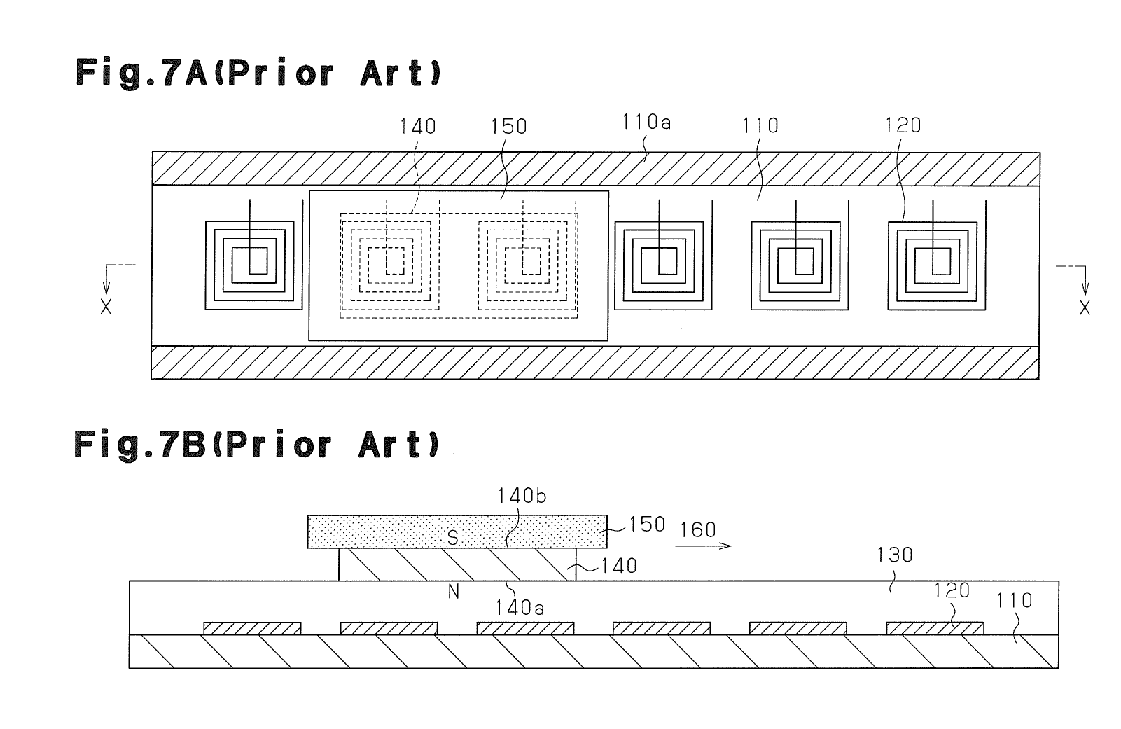

FIG. 7A is a top view of a prior art electromagnetic actuator employing a monopolar magnet. FIG. 7B is a cross-sectional view taken along line X-X of FIG. 7A.

The electromagnetic actuator of FIG. 7A includes a stationary portion 110 and a movable portion 150. A monopolar magnet 140 is attached to the movable portion 150. A plurality of coils 120 are aligned along a straight line at predetermined intervals on an upper surface of the stationary portion 110. A protective film 130 covers the plurality of coils 120. Guide rails 110a are arranged on the stationary portion 110 to guide movement of the movable portion 150 in the queued direction of the coils 120. The monopolar magnet 140 is attached to the lower surface of the movable portion 150. The monopolar magnet 140 has a pole surface 140a (one of two opposite sides of a magnet, such as the north pole) facing toward one or more coils 120. The movable portion 150, which is integrally attached to the monopolar magnet 140, moves relative to the stationary portion 110 (on the protective film 130) in the queued direction of the coils 120 (along the guide rails 110a) spaced by a predetermined distance from the stationary portion 110.

The operation of the electromagnetic actuator of FIG. 7 will be described.

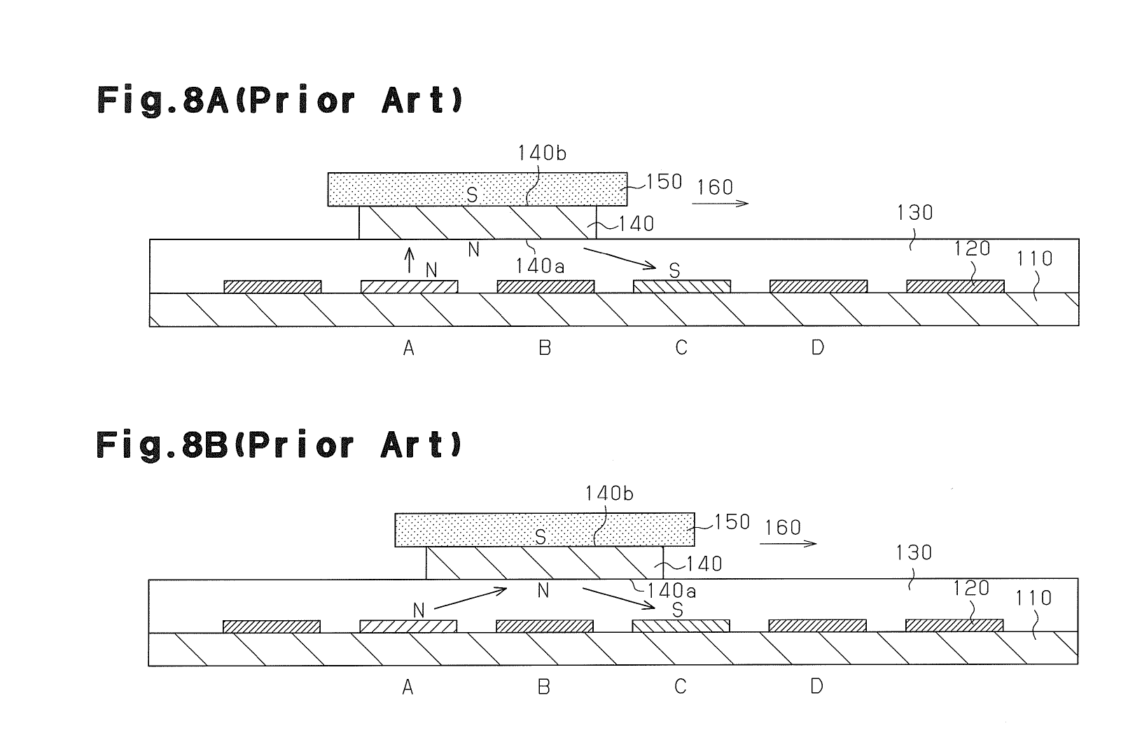

In the state of FIG. 8A, coils A and B are located immediately below the movable portion 150. Coil C is located frontward from the movable portion 150. The current supplied to the coils A to D when moving the movable portion 150 in the driving direction 160 from this state will be described. First, a predetermined current is supplied to coil C so that the upper surface of coil C has a south pole (S-pole) polarity. At the same time, current flows to coil A in a direction opposite to the direction of the current flowing to coil C so that the upper surface of coil A has a north pole (N-pole) polarity. In this state, current is not supplied to coil B, which is located between coils A and C. Current is also not supplied to coil D, which is arranged further frontward from coil C. In this case, magnetic attraction occurs between the N-pole of the monopolar magnet 140, which is attached to the movable portion 150, and the S-pole generated in coil C. Further, magnetic repulsion occurs between the N-pole of the monopolar magnet 140 and the N-pole generated in coil A (FIG. 8A).

In other words, in the state shown in FIG. 8A, the magnetic attraction between the monopolar magnet 140 and coil C produces the thrust for driving the movable portion 150 in the driving direction 160.

When the movable portion 150 moves to the position shown in the state of FIG. 8B, in addition to the magnetic attraction between the monopolar magnet 140 and coil C, the magnetic repulsion between the monopolar magnet 140 and coil A produces the thrust for driving the movable portion 150 in the driving direction 160. This further drives the movable portion 150 in the driving direction 160.

When the movable portion 150 has moved for a distant corresponding to one coil from the state shown in FIG. 8A, the supply of current to coils A and C are stopped. At the same time, the current supplied to coils B and D, which are the coils next to coils A and C, is controlled in the same manner as the current supplied in the state shown in FIG. 8A. In this manner, the movable portion 150 is driven in the queued direction (guide rails 110a) of the coils 120 arranged along the stationary portion 110 by magnetic attraction, magnetic repulsion, or the combination of magnetic attraction and magnetic repulsion between the coil 120 and the monopolar magnet 140.

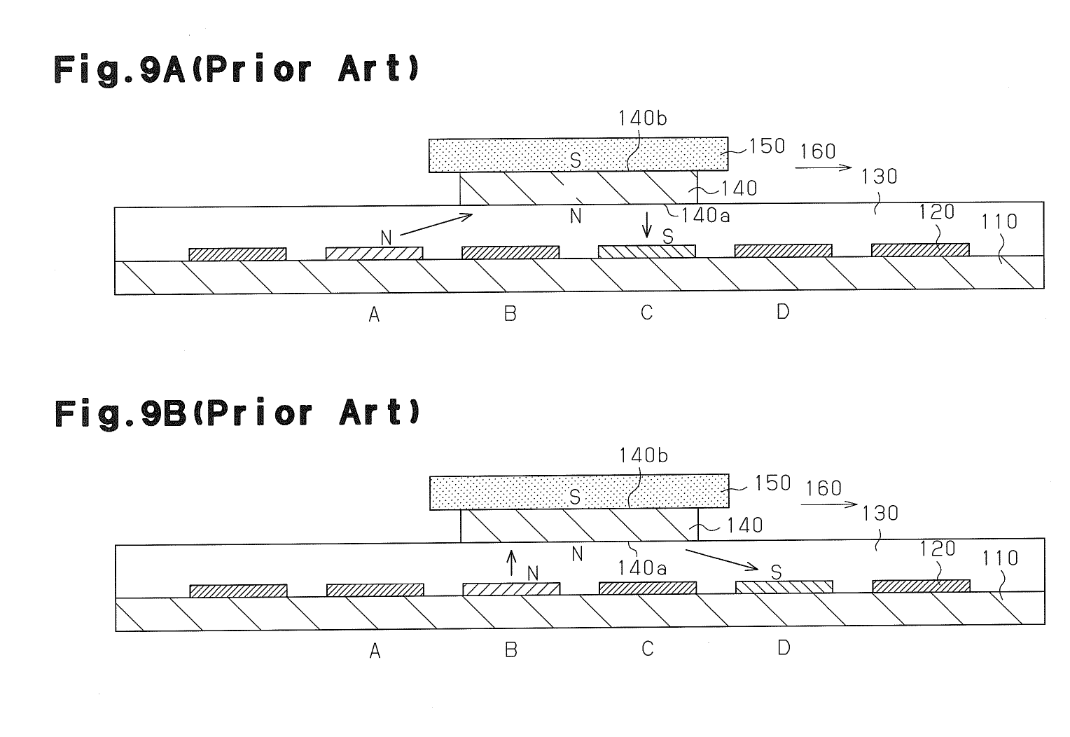

However, when switching the coils supplied with current, the current control executed in the states of FIGS. 8A and 8B has a shortcoming. When shifting to the state shown in FIG. 9A, coil C is located immediately below the monopolar magnet 140. Thus, magnetic attraction acts on the monopolar magnet 140 in a straightly downward direction. When the current supply is switched immediately thereafter, in the state shown in FIG. 9B, magnetic repulsion occurs between the monopolar magnet 140 and coil B, which is located immediately below the monopolar magnet 140, and acts in a straightly upward direction. If an external force is applied to the movable portion 150 at a time of point when the coils supplied with current are switched, that is, at a time of point when upward magnetic repulsion acts on the movable portion 150, the movable portion 150 may be moved away from a predetermined position on the stationary portion 110. In this manner, it is difficult to stably drive the movable portion 150 with the electromagnetic actuator when employing a monopolar magnet as a field magnet.

(2) The coil located immediately below the monopolar magnet 4 attracts the movable portion 5 before and after switching the coils 2 that produce magnetic fields. The magnetic attraction prevents the driven movable portion 5 from being displaced. Since the movable portion 5 is stably driven in the driving direction 6, the driving reliability of the electromagnetic actuator is improved.

(3) The coils (e.g, coils A and C) for producing thrust applied to the movable portions 5 are independent from the coils (e.g., coil B) for attracting the movable portion 5 to the stationary portion 1. The same kind of drive control as in the prior art may be executed by simply modifying the circuit of the current control circuit 50 so that current flows to the coils to attract the driven movable portion 5. This lowers the cost of the electromagnetic actuator in comparison to when employing a separate displacement prevention mechanism for the electromagnetic actuator.

(4) The coil located immediately below the monopolar magnet 4 is selected as the coil (e.g., coil B) for attracting the driven movable portion 5. Thus, the opposing areas of the coil and the monopolar magnet 4 is constant regardless of the position of the movable portion (or movement amount of the movable portion 5). Thus, the movable portion 5 is stably attracted to the stationary portion 1. The further ensures advantages (1) and (2).

(5) In the prior art, the magnetic fields of the plurality of coils are switched using three currents having different phases. In the illustrated example, only one current (current I5a or I5b) is applied to the plurality of coils 2, which include the coils for generating thrust in the movable portion 5 and the coils for attracting the movable portion 5 to the stationary portion 1. This simplifies the current control circuit 50 as compared with a current control circuit of the prior art. Thus, the electromagnetic actuator may be miniaturized while improving the driving reliability.

### Optical Pickup Device

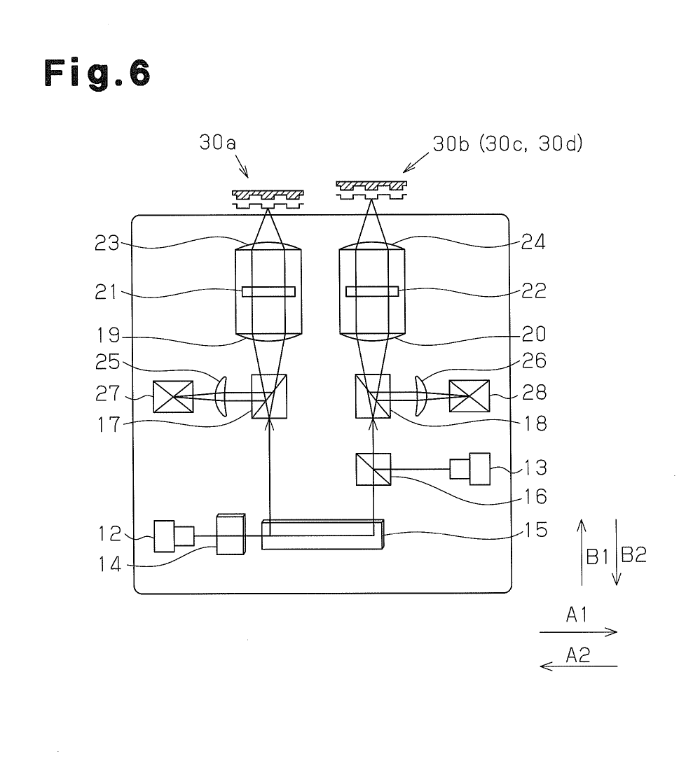

An optical pickup device including an optical component driven by an electromagnetic actuator according to the present invention will now be discussed. FIG. 6 shows one example of an optical pickup device incorporating the electromagnetic actuator according to the preferred embodiment of the present invention.

The optical pickup device of the present invention includes semiconductor lasers 12 and 13, a light reducing filter 14 driven by the above-described electromagnetic actuator, a optical path switching unit 15, a dichroic beam splitter 16, polarization beam splitters 17 and 18, collimator lenses 19 and 20, quarter wavelength plates 21 and 22, objective lenses 23 and 24, light receiving lenses 25 and 26, and light receiving sensors 27 and 28. The optical pickup device is configured to write data to and read data from an optical disc 30a, which is in compliance with the Blu-ray Disc (BD) standard, and an optical disc 30b (30c and 30d), which is in compliance with the HD DVD standard (CD standard and DVD standard).

The semiconductor laser 12 emits a blue-violet laser light having a wavelength of about 405 nm. The semiconductor laser 12 emits laser light when writing data to or reading data from the optical disc 30a of the BD standard or the optical disc 30b of the HD DVD standard.

The semiconductor laser 13 emits laser lights of two wavelengths, a red laser light having a wavelength of about 650 nm and a near infrared laser light having a wavelength of about 785 nm. The semiconductor laser 13 emits the laser light having the wavelength of about 785 nm when writing data to or reading data from the optical disc 30c of the CD standard and emits the laser light having the wavelength of about 650 nm when writing data to or reading data from the optical disc 30d of the DVD standard.

The light reducing filter 14 is supported by a light reducing filter actuator, which employs the electromagnetic actuator of the present invention, and is movable between two positions (position on optical path and position separated from the optical path) along a direction (direction of arrows B1 and B2) perpendicular to the direction of the laser light optical axis (A1 direction). The light reducing filter 14 is arranged at a position located in the optical path when reading data and is arranged at a position separated from the optical path when writing data. Thus, the light reducing filter 14 reduces the intensity of the laser light emitted from the semiconductor laser 12 only when reading data. The light reducing filter 14 is one example of an “optical component” of the present invention.

The optical path switching unit 15 moves an internal movable mirror (not shown) so that the laser light emitted from the semiconductor laser 12 selectively enters one of the objective lenses 23 and 24.

The dichroic beam splitter 16 transmits the laser light emitted from the semiconductor laser 12 and reflects the laser light emitted from the semiconductor laser 13. Thus, the laser light emitted from the semiconductor laser 12 can enter the objective lens 24, and the laser light emitted from the semiconductor laser 13 can enter the objective lens 24.

The polarization beam splitters 17 and 18 respectively transmit the laser light directed towards the optical discs 30a and 30b (30c and 30d) in the direction of the arrow B1. Further the polarization beam splitters 17 and 18 respectively reflect the laser light returning from the optical discs 30a and 30b (30c and 30d) in the direction of the arrow B2.

The collimator lenses 19 and 20 convert the laser beam to a collimated light having a predetermined beam diameter and adjust the focal position of the laser light.

The quarter wavelength plates 21 and 22 convert the laser light directed towards the optical discs 30a and 30b (30c and 30d) in the direction of the arrow B1 from linear polarization to circular polarization. Further, the quarter wavelength plates 21 and 22 convert the laser light returning from the optical discs 30a and 30b (30c and 30d) in the direction of the arrow B2 from circular polarization to linear polarization, which is orthogonal to the laser light directed towards the optical discs 30a and 30b (30c and 30d) in the direction of the arrow B1.

The objective lenses 23 and 24 are movable in the optical axis direction (direction of arrows B1 and B2) and in the direction perpendicular to the optical axis (direction of arrows Al and A2). The objective lenses 23 and 24 adjust the focal position of the laser light.

The light receiving lenses 25 and 26 respectively focus the laser light reflected by the polarization beam splitters 17 and 18 on the light receiving sensors 27 and 28.

The optical pickup device of the present invention has the advantage described below.

(6) Positioning errors are prevented during operation of the electromagnetic actuator (light reducing filter 14). This improves the driving reliability of the electromagnetic actuator. Thus, the reliability of the optical pickup device incorporating the electromagnetic actuator is improved.

It should be apparent to those skilled in the art that the present invention may be embodied in many other specific forms without departing from the spirit or scope of the invention. Particularly, it should be understood that the present invention may be embodied in the following forms.

In the above embodiment, the pole surface 4a of the monopolar magnet 4 facing the coil 2 is an N-pole. However, the present invention is not limited in such a manner. For example, the pole surface 4a of the monopolar magnet 4 may be an S-pole. In such a case, the current direction is changed so that each coil 2 produces a magnetic field reversed from that of the above embodiment. This obtains the same advantages as the above embodiment.

In the above embodiment, the movable portion 5 is moved in the driving direction 6 along the queued direction (guide rails 1a) of the coils 2. However, the present invention is not limited in such a manner. The movable portion 5 may be moved in a direction opposite to the driving direction 6 by supplying current to the coils 2 in the opposite direction. The movable portion 5 may also reciprocate in the queued direction (guide rails 1a) by controlling the current supplied to the coils 2. In this case, the same advantages as the above embodiment would also be obtained.

In the above embodiment, a plurality of coils is aligned along a straight line at predetermined intervals. However, the present invention is not limited in such a manner. The plurality of coils may be aligned along a curved line or along a combination of straight lines and curved lines. In this case, the same advantages as the above embodiment would also be obtained. In particular, the advantages are more significant at portions where the coils are aligned along a curve line since the driven movable portion tends to be displaced by centrifugal force.

In the optical pickup device described above, the electromagnetic actuator of the present invention is applied to the light reducing filter 14. However, the present invention is not limited in such a manner. The electromagnetic actuator of the present invention may be applied to an optical path switch mirror actuator (actuator for driving the movable mirror) arranged on the optical path switching unit 15. In this case, positioning errors are prevented during operation of the optical path switching unit 15. This improves the driving reliability of the optical path switching unit 15, which in turn improves the reliability of the optical pickup device incorporating the optical path switching unit 15.

The electromagnetic actuator of the present invention is not limited to an optical pickup device and may be applied to a drive mechanism for high-precision apparatuses, such as a semiconductor manufacturing device, a liquid crystal manufacturing device, and a machine tool. This would increase the accuracy of the apparatus and improve the functions of the apparatus.

The present examples and embodiments are to be considered as illustrative and not restrictive, and the invention is not to be limited to the details given herein, but may be modified within the scope and equivalence of the appended claims.

What is claimed is:

1. An electromagnetic actuator comprising:
a base plate including a plurality of electric wires queued in a queued direction at an interval, with each electric wire producing a magnetic field when supplied with current; and
a movable portion mounted on the base plate and movable relative to the base plate in the queued direction, with the movable portion including a pole surface facing toward the electric wires,
wherein the movable portion is moved in the queued direction when magnetic attraction or magnetic repulsion occurs between the pole surface and the magnetic field produced by the electric wires, and wherein the pole surface is magnetically attracted by at least one of the electric wires facing toward the pole surface when the movable portion is being moved in the queued direction.

2. The electromagnetic actuator according to claim 1, wherein the plurality of electric wires include,
a first electric wire which applies thrust to the movable portion; and
a second electric wire which differs from the first electric wire and attracts the movable portion.

3. The electromagnetic actuator according to claim 2, wherein the same current flows to the first electric wire and the second electric wire.

4. The electromagnetic actuator according to claim 1, wherein the plurality of electric wires include:
a first electric wire which attracts the movable portion;
a second electric wire which faces toward the pole surface and attracts the movable portion; and
a third electric wire which repulses the movable portion, with the second electric wire being arranged between the first electric wire and the second electric wire, and the first electric wire or the third electric wire generates thrust that is applied to the movable portion when the second electric wire is attracting the movable portion.

5. An optical pickup device comprising an electromagnetic actuator and an optical component driven by the electromagnetic actuator, wherein the electromagnetic actuator includes:
a base plate having a plurality of electric wires queued in a queued direction at an interval, with each electric wire producing a magnetic field when supplied with current; and
a movable portion mounted on the base plate and movable relative to the base plate in the queued direction, with the movable portion including a pole surface facing toward the electric wires, wherein the movable portion is moved in the queued direction when magnetic attraction or magnetic repulsion occurs between the pole surface and the magnetic field produced by the electric wires, and wherein the pole surface is magnetically attracted by at least one of the electric wires facing toward the pole surface when the movable portion is being moved in the queued direction.

6. An electromagnetic actuator comprising:
a stationary portion including a plurality of coils queued in a queued direction at an interval, with each coil producing a magnetic field when supplied with current; and
a movable portion mounted on the stationary portion and movable relative to the stationary portion in the queued direction;
a permanent magnet arranged on the movable portion and including a pole surface facing toward the coils; and
a current control circuit which controls current supplied to the coils;
wherein the movable portion is moved in the queued direction when magnetic attraction or magnetic repulsion occurs between the pole surface and the magnetic field produced by each coil, and the current control circuit controls the current supplied to the coils to constantly attract the pole surface by at least one of the coils facing toward the pole surface over a time period in which the movable portion is moved.

7. The electromagnetic according to claim 6, wherein the current control circuit supplies the same current to a first one of the plurality of coils which applies thrust to the movable portion and a second one of the plurality of coils which applies attraction to the movable portion.

8. The electromagnetic according to claim 6, wherein the current control circuit controls the current supplied to first, second, and third ones of the coils that are successively queued in the queued direction so that the first or third one of the coils applies thrust to the movable portion while the second one of the coils, which is arranged between the first coil and the third coil, attracts the movable portion.
